(19) United States
(12) Patent Application Publication
(10) Pub. No.: US 2002/0138366 A1
(43) Pub. Date: Sep. 26, 2002

(54) Method and device for issuing and redeeming gift certificates on an e-commerce site

(76) Inventor: Kristofer Skantze, Lund (SE)

Correspondence Address: BIRCH STEWART KOLASCH & BIRCH, PO BOX 747, FALLS CHURCH, VA, 22040-0747, US

(21) Appl. No.: 10/101,928

(22) Filed: Mar. 21, 2002

Related U.S. Application Data
(60) Provisional application No. 60/277,999, filed on Mar. 23, 2001.

(30) Foreign Application Priority Data
Mar. 21, 2001 (SE) 0100989-3

(51) Int. Cl. G06F 17/60

(52) U.S. Cl. 705/26

(57) ABSTRACT

A method, a device, a computer program product and a product package for issuing and redeeming gift certificates on an e-commerce site. The method comprises receiving an order for a gift certificate from a first user. The order comprises at least a credit amount and information for identifying a second user who is to be permitted to utilize the credit amount. The second user is provided with an information carrier which is provided with a position-coding pattern which codes coordinates for a plurality of points on an imaginary surface. The points represent at least one product offered by the e-commerce site. Coordinates for at least one point and information that identifies the second user are received from the second user, via a computer network. This information is used to identify the credit amount that the user is permitted to utilize. Thereafter, an amount corresponding to the price of the product corresponding to the received coordinates is deducted from the credit amount.

### FIELD OF INVENTION

The present invention relates to methods, a device, a computer program product and a product package for issuing and redeeming gift certificates on an e-commerce site.

### BACKGROUND ART

In association with e-commerce, particularly between businesses and consumers, it is often the case that e-commerce sites, such as www.barnesandnoble.com, www.wine.com and www.giftcertificates.com, provide electronic gift certificates. These enable a first user, who wants to order an electronic gift certificate, to specify a credit amount and a recipient of this credit amount, via a form that is downloaded from the e-commerce site.

The credit amount is usually deducted from a credit card account specified by the first user. Thereafter, the e-commerce site sends a message to the recipient, which message contains information that the recipient is able to buy products on the e-commerce site up to the value of a particular credit amount. In addition, the message contains, according to prior-art technique, a unique identification number. The recipient can then log on to the e-commerce site, select the products he or she wants to buy. At the “check-out” the recipient gives the identification number, whereupon payment is taken from the credit amount instead of the recipient needing to give, for example, credit card information. Instead, the amount is taken from the credit card account of the first user, either at the time of ordering the electronic gift certificate or at the time of the recipient making the purchase.

A more automated variant of such a method is used by www.amazon.com and www.cdnow.com This method is disclosed in U.S. Pat. No. 6,175,823. According to U.S. Pat. No. 5,175,823 the message to the recipient contains a hyperlink which, when the recipient clicks on the link, automatically transfers the credit amount of the electronic gift certificate to a credit balance in the recipient's electronic shopping cart. In this way, the recipient does not need to enter the identification number, which simplifies and speeds up the purchase, in addition to reducing the risk of incorrect entry.

A problem with both the variants of prior-art technique is that the recipient must have access to a computer with Internet connection, so that he or she can access the e-commerce site at the ti me when he or she wants to make the purchase. Parts of the population have no, or only limited, access to a computer with Internet connection. In addition, it often takes a long time for the recipient to download, for example, pictures of the products in which he or she is interested.

Another problem is that some recipients do not have sufficient command of computer technology to enable them to buy goods via an e-commerce site.

### SUMMARY OF THE INVENTION

An object of the present invention is to solve the above-mentioned problems completely or partially This object is achieved according to the invention by a method according to claims 1-7 and 8-12, a device according to claims 13-16, a computer program product according to claims 17-21 and a product package according to claim 22.

According to the invention, a method for issuing and redeeming gift certificates on an e-commerce site comprises the steps of receiving an order for a credit balance from a first user, which order comprises at least a credit amount and information for identifying a second user who is to be permitted to utilize the credit amount; providing at least the second user with an information carrier, which is provided with a position-coding pattern which codes coordinates for a plurality of points on an imaginary surface, which points represent at least one product offered by the e-commerce site; receiving From the second user, via a computer network, coordinates for at least one point of said plurality of points and information that identifies the second user; by means of the information that identifies the second user, identifying the credit amount that the second user is entitled to utilize; and deducting from the credit amount an amount corresponding to the price of the product corresponding to the received coordinates.

A method according to the present invention makes it possible to give away an electronic gift certificate which enables the recipient to order goods from an information carrier, for example a mail order catalogue, without having to be continuously connected to the Internet page of the e-commerce site. The choice of products can be carried out at the place and time that suits the recipient of the gift certificate. Connection and sending the order can be carried out at a later time.

The method has the further advantage that the e-commerce site can make contact with people who would not normally use e-commerce sites, preferring instead more traditional mail-order shopping.

In addition, the method according to the invention means that the user does not need to download information about the products which he or she is interested in choosing between. The user obtains the information using the information carrier or catalogue that is sent to the user. In this way, the amount of information sent electronically by the user is reduced, which reduces the requirements for the user's bandwidth access and can also reduce the user's costs in a situation where the computer network operator charges the user relative to the amount of data that the user has transferred.

In addition, the user automatically receives a paper hard copy of his order, which however does not exclude the e-commerce site confirming the order via e-mail or in some other suitable way, for example by an ordinary letter.

In addition, the e-commerce site does not need to provide electronic information about the products it is offering. It is sufficient for it to be able to handle the ordering of goods and electronic gift certificates.

The first user and the second user can be one and the same person.

Instead of products, the a-commerce site could offer services, which accordingly in this case are to be regarded as equivalent to products.

According to an embodiment of the method, the step of receiving coordinates comprises more particularly receiving coordinates for a series of points of said plurality of points and further comprises the step of determining a specification of the product, such as the product's size, color or configuration, on the basis of a positional relationship between the points in the series. For this purpose, ICR software (Intelligent Character Recognition) can be used to interpret the specification. In this way, the e-commerce sire can let its customers provide information about the product or products they are ordering, which also facilitates the design of the information carrier as it does not need to have so many pre-specified fields and boxes for order information.

The method according to the invention can further comprise the step of receiving payment information from the first user, which payment information makes possible the utilization of an amount corresponding to the credit amount from a payment account associated with the first user. By means of this step, the e-commerce site obtains payment from the first user. If the first user gives, for example, a credit card account number from which payment for the credit balance can be taken, the whole order can be handled electronically.

The method according to the invention comprises the step of sending an electronic message to the second user comprising at least information about the credit amount. This step contributes towards making the second user aware that the credit amount is available and can be utilized. The message can also comprise a greeting from the person giving the gift certificate. It can also specify a user unit that must be used in order for the credit amount to be able to be utilized, and information about the company or companies for which the credit balance is valid.

The method according to the invention can further comprise the step of receiving coordinates from the second user, via the computer network, for at least two points of said plurality of points, which coordinates correspond to at least two products. In this way, the second user can send coordinates for a plurality of products to the e-commerce site in one and the same electronic message and thus utilize the credit balance for ordering several products at a time.

The information carrier which is used according to the invention may be a printed medium such as, for example, a mail-order catalogue, a magazine or some form of product catalogue or leaflet.

As described above, the user can utilize his credit balance without needing to keep track of electronic messages with identification numbers and hyperlinks. It is sufficient that he identifies himself in the message that is sent to the e-commerce site when he utilizes the gift certificate. The user can identify himself by writing freehand, for example, his name and address, a customer number and/or civic registration number in a place on the information carrier intended for the purpose. This place is also provided with a subset of a position-coding pattern which makes it possible to record handwriting electronically. This subset can be dedicated on the e-commerce site to information that identifies the second user, so that the second user can more easily be identified as such.

In one embodiment, the Information that identifies the second user is an identification code, for example an alphanumeric code or other sequence of characters or symbols, defining a user unit that the second user used to record the coordinates.

The identification code can be included automatically in the message to the e-commerce site, whereby the user does not need to concern himself at all about how he is to be able to utilize his credit balance. The connection between user and user unit and hence the credit balance can be stored on the e-commerce site or in some ,other location that makes it possible for the e-commerce site to gain access to the information. Alternatively, the person ordering the gift certificate can indicate the connection.

The invention also comprises a method for utilizing a credit balance on an e-commerce site, which method comprises the steps of recording electronically from an information carrier which is provided with a position-coding pattern which codes coordinates for a plurality of points on an imaginary surface, which points represent at least one product offered by the e-commerce site, the coordinates for at least one point by reading off the position-coding pattern by means of a user unit, and sending to the e-commerce site, by means of the user unit via a computer network, said coordinates and information that makes it possible to identify a credit balance that is to be used to pay for the product This method is performed by the second user when he or she wants to redeem a credit balance or electronic gift certificate on an e-commerce site. It simplifies the second user's utilization of the credit balance as he can be in any location and look through, for example, a catalogue, and make the order from the catalogue. If the user unit is provided with a pen point so that the marks that the user makes with the user unit on the information carrier are visible as ink marks, the user obtains straight away a readable hard copy of the order.

This method comprises the step of giving approval for the e-commerce site to deduct an amount corresponding to a price for the product from the credit amount. The approval can be carried out by ticking a special box on the information carrier, by confirming the order by computer or mobile telephone or in some other suitable way.

In addition, the method comprises the step of receiving an electronic message from the e-commerce site, which message comprises at least the credit amount.

The method according to the invention may also comprise the step of producing a specification of the product by writing the specification on the position-coding pattern with the user unit so that the specification is recorded electronically in the form of a series of coordinates.

The ability to write text, numbers, etc, freely on the position-coding pattern facilitates the utilization of the credit balance.

The invention further comprises a device for providing and utilizing a credit balance on an e-commerce site, which device comprises an order processing module, which is arranged to receive from a second user information identifying the second user, and coordinates for at least one point on an imaginary surface, which coordinates have been recorded by reading off a position-coding pattern on an information carrier by means of a user unit, which position-coding pattern codes coordinates for a plurality of points on the imaginary surface, which points represent at least one product offered by the e-commerce site, and an redemption module, which is arranged to identify, by means of information that identifies the second user, a credit amount that the second user is entitled to utilize and to deduct an amount corresponding to a price of the product from the credit amount.

The advantages of the device are apparent from the above. The device can be realized as a server unit in a computer network, which server unit can be accessed via a standardized World-Wide-Web protocol.

The invention also comprises a computer program product that comprises program code for the issuing and redemption of gift certificates on an e-commerce site, which computer program product icon execution carries out or makes possible the implementation of the methods as described above.

The advantages of the computer program product are apparent from the above.

Finally, the invention also comprises a product package for providing and utilizing a credit balance on an e-commerce site, which product package comprises at least one information carrier, which is provided with a position-coding pattern which codes coordinates for a plurality of points on an imaginary surface, which points represent at least one product offered by the e-commerce site, at least one user unit for electronic recording said position-coding pattern, and at least one credit balance on the e-commerce site. When a user buys a product package according to the invention, he will not only acquire a user unit, but also an information carrier, for example a mail-order catalogue, plus a credit balance on an e-commerce site. The user will perceive the product package as advantageous, as it contains a credit balance on an e-commerce site. For the e-commerce site, the product package is an opportunity to attract new users to the site and to accustom them to buying goods using a user unit. For the manufacturer of -he user unit, the product package also is an opportunity to accustom users to using user units and information carriers for making purchases, which can be expected to lead to increased demand for user units.

Further objects, features and advantages of the invention will become apparent from the following description of the invention in greater detail and with reference to the attached schematic drawings, which for the purpose of exemplification show embodiments of the invention.

### BRIEF DESCRIPTION OF THE DRAWINGS

FIG. 1 is a schematic diagram of a system according to a first embodiment of the present invention.

FIG. 2 is a schematic diagram of a user unit according to the embodiment of FIG. 1.

FIG. 3 is a schematic diagram of an information carrier according to the embodiment of FIG. 1.

FIG. 4 is a schematic diagram showing in more detail a part of an information carrier according to the embodiment of FIG. 1.

FIG. 5 is a schematic diagram showing in even more detail a part of an information carrier according to FIG. 4.

FIG. 6 is a schematic diagram showing a detailed part of an information carrier according to FIG. 4.

FIG. 7 is a schematic diagram showing a part of an address server according to the embodiment of FIG. 1.

FIG. 8 is a schematic diagram showing a part of an e-commerce site according to the embodiment of FIG. 1.

FIG. 9 is a schematic diagram showing an order form for an e-commerce site according to the embodiment of FIG. 1.

FIG. 10 is a schematic diagram showing an imaginary surface which is created by a position-coding pattern.

FIG. 11 is a schematic diagram showing a second embodiment of the system according lo FIG. 1.

### DETAILED DESCRIPTION OF EMBODIMENTS OF THE INVENTION

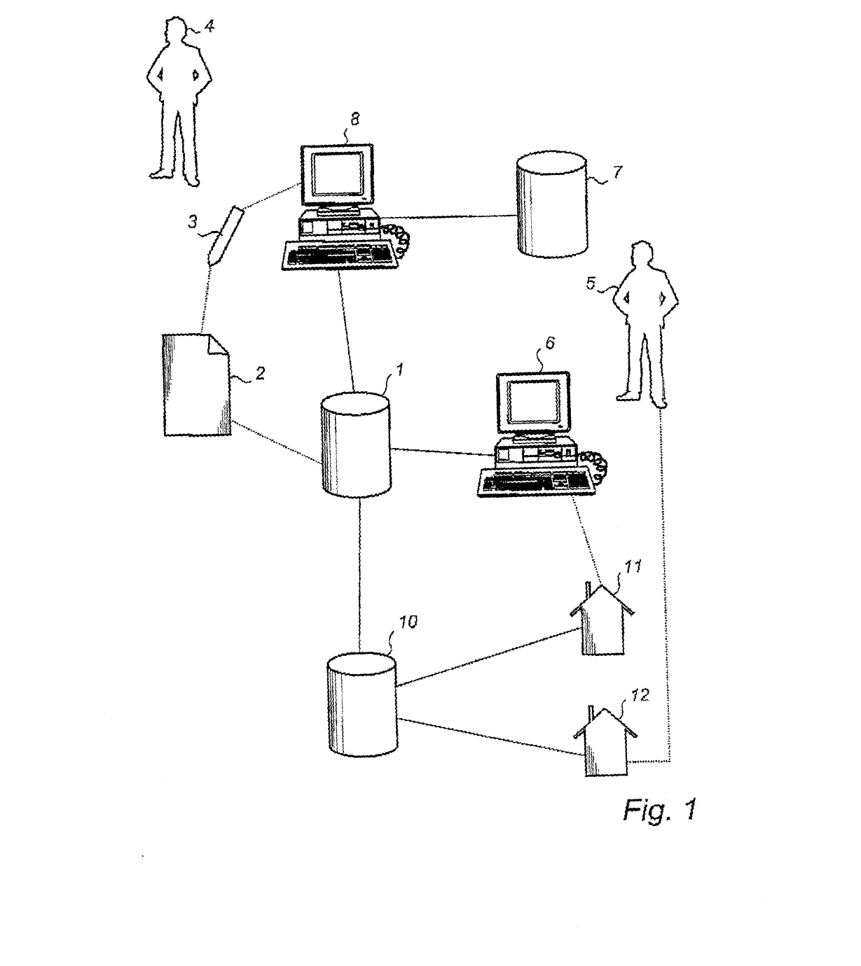

With reference to FIG. 1, a system for the issuance and redemption of gift certificates comprises an e-commerce site 1, an information carrier 2, a user unit 3, a first terminal 6 and a second terminal 8, which may be a mobile terminal. In addition, the system comprises an address server 7 and a payment server 10 which is connected to at least a first account-controlling institute 11 and a second account-controlling institute 12.

### E-COMMERCE SITE

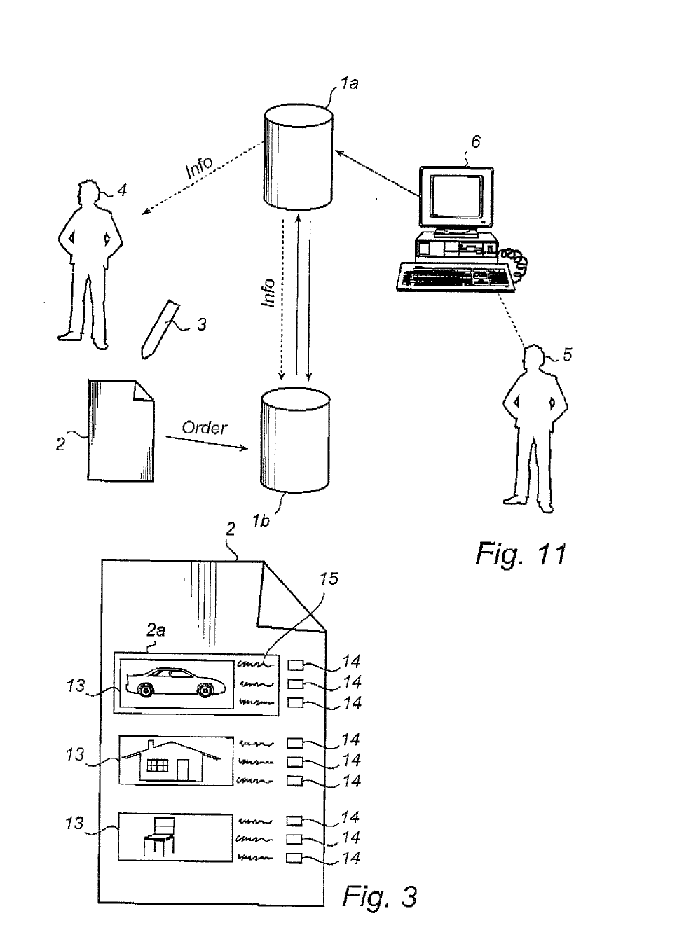

With reference to FIG. 3, the e-commerce site 1 comprises, in addition to the functionality that is required in order to carry out electronic trading in a computer network, preferably over the Internet, an order form 29 that can be downloaded, a communication module 30, a order-processing module 21, a redemption module 32 and a message-generation module 37.

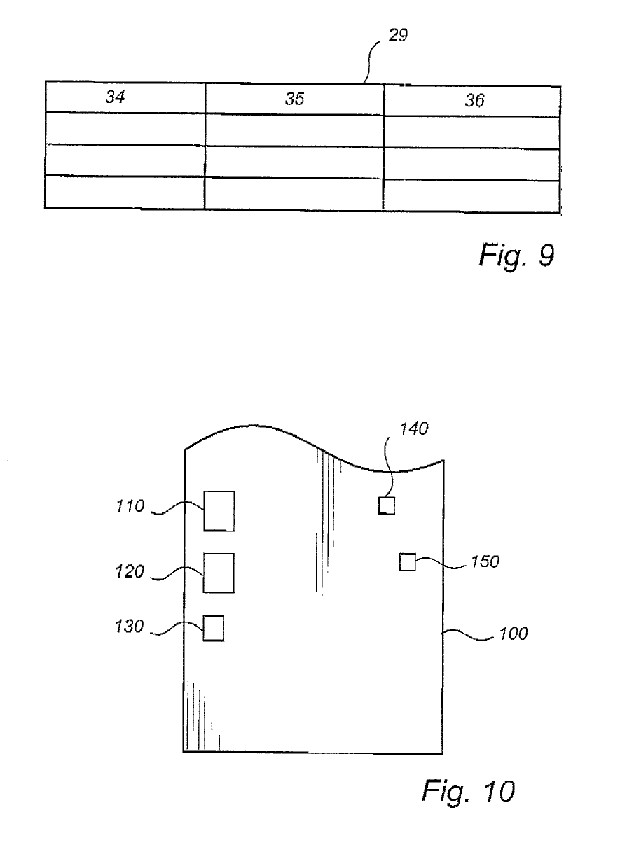

FIG. 9 shows the order form 29 that can be down-loaded and has the functionality that a first user 5 is able to order an electronic gift certificate. The order form 29 comprises fields for indicating a credit amount 35 and for identification 34 of a second user 4, who is a recipient of the credit balance and who is to be permitted to buy goods to the value of the credit amount. In addition, the order form comprises a field for payment information 26 that is required in order for the e-commerce site 1 to be able to obtain payment from the first user 5. The identification information 34 can be an e-mail address of the second user. The payment information 36 may be a credit card or debit card number.

The communication module 30, by means of which the e-commerce site 1 can communicate with a user unit 3, possibly via a second terminal B, may utilize suitable standardized Internet protocols.

The order-processing module 31 receives information from a user unit 3, indicating which products the second user 4 wants to order from the e-commerce site 1.

The redemption module 32 deducts the price of the products that the second user 4 wants to order from the credit amount.

The message-generation module 37 generates messages to the second user, comprising information about the size of the credit balance.

### INFORMATION CARRIER

With reference to FIGS. 3, 4, 5 and 6, the information carrier 2 comprises specifications 2a of one or more products which are provided by the e-commerce site. Such a specification 2a comprises, for example, a picture of the product 13 and information text 15, which for the sake of simplicity is represented by wavy lines. In addition, the information carrier 2 comprises, either separately or in direct association with the specification 2a, option boxes or fields 14 in which the second user 4 can mark his orders. Each option box 14 is provided with a subset of a position-coding pattern 1c, which codes coordinates for points on an imaginary surface, which will be described below. The points that are coded by the position-coding pattern in an option box represent a product provided by the e-commerce site.

FIG. 3 shows an information carrier in the form of a sheet of paper. Of course, the information carrier can contain several sheets of paper with similar or other contents.

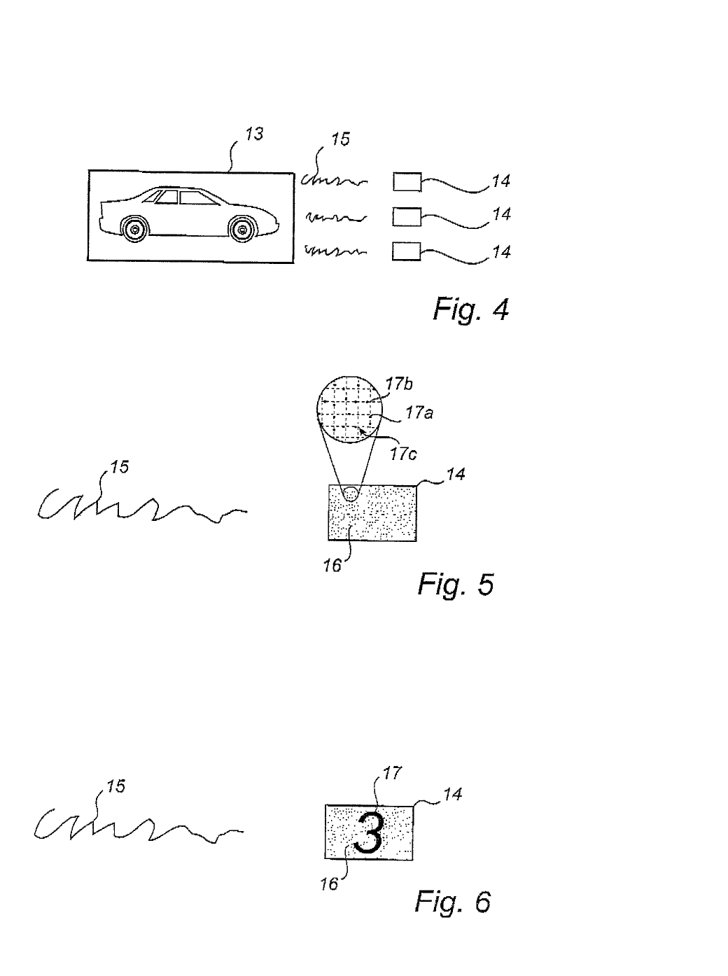

FIG. 4 shows a part of the information carrier in FIG. 3 in more detail. In particular, it shows a picture 13 of a product in the form of a car, three option boxes 14, that correspond to different variants of the car, for example, the car with different types of optional extras, and three product information texts 15 that describe the different variants of the car, which are only indicated by wavy lines.

FIG. 5 shows an even smaller part of the information carrier in FIG. 3, namely an option box 14 and associated product information text 15. In the option box, there is a subset of a position-coding pattern 16, which however is only shown schematically, A small part of the position-coding pattern is shown enlarged.

FIG. 6 is essentially the same as FIG. 5. However, it shows a product specification 17 in the form of the number three which a user has written in the option box

### POSITION-CODING PATTERN

The position-coding pattern on the information carrier can be of the type that is shown in U.S. Pat. No. 5,852,434, where each absolute position on a writing surface is coded by a discrete symbol. However, the position-coding pattern may alternatively be of the type shown in the international patent application WO 01/16591 or the international patent application WO 00/73983, both of which are assigned to the Applicant and are incorporated herein by reference. In these applications, each position or point on the imaginary surface is coded by a plurality of symbols. The absolute position-coding pattern is floating, so that any arbitrary, partial surface of a predetermined size codes coordinates for a position or a point.

FIG. 5 shows, as already mentioned, a schematic enlargement of the absolute position-coding pattern is in the option box 14. The position-coding pattern shown is of the type described in WO 01/116691. It is constructed of a number of dots 17a. Each dot can occupy one of four different predetermined positions in relation to a raster point 17b in an orthogonal raster 17c, Depending upon its position, the dot represents any one of the values (0,0; 0,1; 1;0; and 1,7), where the first bit in each value is used to determine an x-coordinate and the second bit is used to determine a y-coordinate for a point at the imaginary surface. 8×6 symbols may code the coordinates for a point. In the enlargement in FIG. 5, the raster 17c is indicated for the sake of clarity. However, the raster is normally virtual, i.e non-visible but it may be determined by calculations.

The position-coding pattern may have such a resolution that it is possible to record handwritten text by having the user unit continually read off the position-coding pattern within its field of vision when the user writes on the position-coding pattern using the user unit. A normal resolution is 0.3 mm, but the resolution may be increased tenfold by interpolation, i.e. 0.03 mm.

As shown in FIG. 6, the user can write a specification of the product that is to be ordered by writing in the option box using the user unit. The specification can, for example, consist of the number 16 of products that the second user 4 wants to order. The user unit generates a series of coordinates that represent the specification, for example 100 coordinates per second.

### USER UNIT

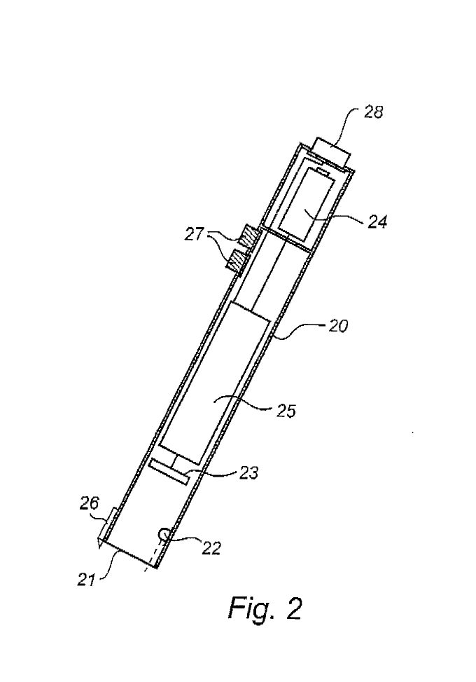

FIG. 2 shows an example of a user unit 3, which in this case consists of a digital pen. It comprises a casing 20 which has approximately the same shape as a pen. In the short side of the casing there is an opening 21. The short side is intended to abut against or to be held a short distance from the surface from which a position-coding pattern is to be read off.

The casing comprises an optics part, an electronic circuitry part and a power supply.

The optics part comprises at least one light-emitting diode 22 for illuminating the surface which is to be imaged and a light-sensitive area sensor 23, for example a CCD or CMOS sensor, for recording a two-dimensional image. If required, the device can also contain a lens system and other optical components, such as an aperture.

The power supply for the device is obtained from a battery 24, which is mounted in a separate compartment in the casing, or via a cable.

The user unit also comprises a pen point 26, which can be used to write ordinary pigment-based writing in the form of traces, which are simultaneously recorded by the user unit by means of the position-coding pattern. The pen point 26 is extendable and retractable for controlling whether or not it is to be used.

The user unit also comprises control buttons 27, by means of which the device can be activated and controlled. It has also a transceiver 28 for wireless communication, for example using infrared light or radio waves, with external units.

The electronic circuitry part contains a processor 25 which is programmed to read an image from the sensor 23, identify symbols in the image, determine which coordinates the symbols code and store these coordinates into its memory. The processor 25 is further programmed to analyze stored pairs of coordinates and, where applicable, to convert these into a train of polygons or vectors that constitutes a description of how the user unit has been moved across a surface that is provided with the position-coding pattern This train of polygons thus represents the information that was detected and recorded using the user unit. The processor 25 is further programmed to select a pair of coordinates from among the recorded pairs of coordinates and to send this pair of coordinates to the terminal 8 via the transceiver 28. Finally, the processor 25 is programmed to send all the recorded information to an address that it receives from the server unit in response to the sending of the pair of coordinates.

The user unit has a unique identity code that may consists of a serial number that is stored in a memory. The processor 25 may be programmed to include this serial number in a message sent from the user unit so that the user unit can be identified.

### FIRST TERMINAL

The first terminal 6, see FIG. 1, may be a computer, a WAP telephone or similar device, which can be connected to the e-commerce site 1 via a computer network, for example the Internet, and can download the electronic order form 29.

### SECOND TERMINAL

The second terminal 8 may be, like the first terminal 6, a computer, a WAP telephone, a normal mobile telephone with a built-in modem or a similar device, which can be connected to the e-commerce site 1 via a computer network, for example the Internet. The second terminal 8 is, however, also arranged to communicate with the user unit 3 via, for example, a cable, infrared light or radio waves.

### ADDRESS SERVER

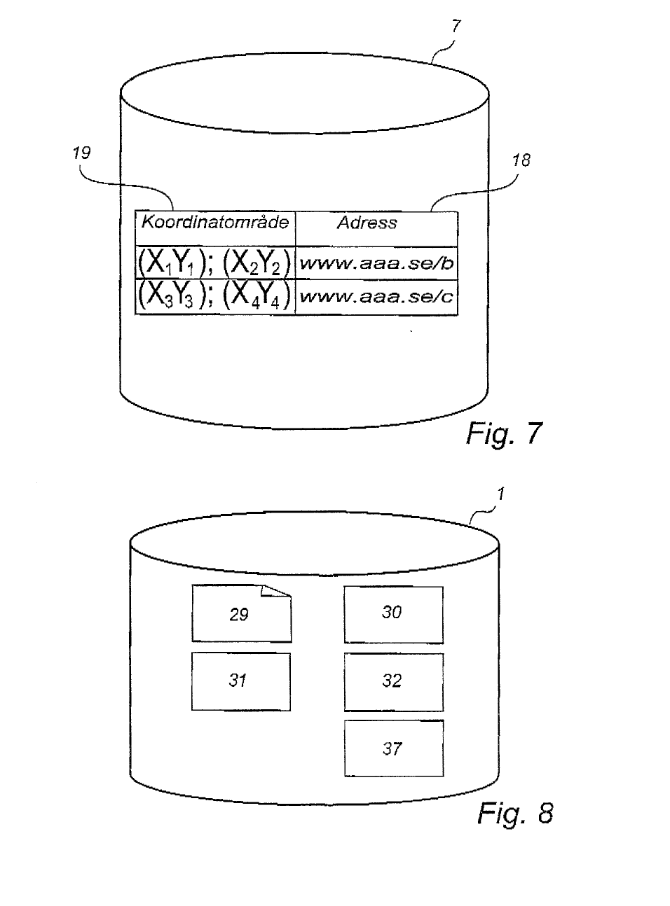

With reference to FIG. 7, the address server is a server unit that comprises functionality for relating coordinates that were recorded using a position-coding pattern to network addresses. In the address server, or in one or more memories that can be accessed by the address server, information is stored about different coordinate areas on an imaginary surface. The imaginary surface is formed of or made up by all the points that can be coded by the position-coding pattern. It is called imaginary, as it does not exist anywhere.

On the imaginary surface 100, which is shown very schematically in FIG. 10, different coordinate areas 110-150 can be defined. Certain coordinate areas, for example 110-130, can be licensed or reserved in some way for different companies. These can be used to define products on the information carrier. Different sub-areas within the coordinate areas can be dedicated to different products. Other coordinate areas, for example 140-150, can be reserved for other purposes, such as special functions. The coordinate areas can, for example, be defined by means of the coordinates of two of their corner points, as shown schematically in FIG. 7. An address 18, for example a network address, can be associated with each coordinate area 19.

The address server also comprises Functionality to communicate via a computer network with a user unit 3 or a terminal 8. When the address server receives coordinates from the user unit 3 or the terminal 8, it determines to which coordinate area the received coordinates belong and returns in response the associated network address.

### PAYMENT SERVER

The payment server 10 is arranged to communicate with the e-commerce site 1 via a computer network. The payment server is arranged to receive payment information from the e-commerce site. Based on the payment information, the payment server implements the payment from the first user's account-keeping institute 12 to the e-commerce site's account-keeping institute 11.

### FUNCTION OF THE SYSTEM

According to a first embodiment of the present invention, the system operates in such a way that a first user 5 orders an electronic gift certificate via a first terminal 5 and an order form 29 that can be downloaded, by entering on the order form 29 (see FIG. 9) at least one credit amount 35 and information 34 which is sufficient to indicate uniquely a second user 4, who is to be permitted to buy goods on the e-commerce site 1 to the value of the credit amount 35.

The first user also supplies payment information 36 to the e-commerce site, based on which the e-commerce site obtains payment via a payment server 10 that transfers an amount corresponding to the credit amount 35 from the first user's account-keeping institute 12 to the e-commerce site's account-keeping institute 11.

When the form 29 is filled in and sent to the e-commerce site 1, a message is sent to the second user.

The second user is provided with an information carrier 2. This information carrier may be a printed medium, produced by or at the request of the e-commerce site 1. The information carrier may be a catalogue that is distributed by the e-commerce site at certain intervals. The distribution can thus be completely independent of the receipt of the credit balance by the second user.

The second user 4 marks on the information carrier 2 with the user unit 3 which products or services he or she wants to order. The marks are made by the user 4 writing with the pen point 26 or ticking in option boxes 14 on the information carrier 2, whereby the pen's sensor 23 records the part of the position-coding pattern 16 that is marked by the user 4- The second user can also write other information than the information in the option boxes. He can, for example, sign his order in a place intended for this purpose, provide information identifying himself, or write any message to the recipient.

The recorded part of the position-coding pattern is then converted by the user unit 3 into pairs of coordinates, which are sent to the address server 7 via the terminal 8 and the computer network. The actual dispatch of the message can be controlled by means of an activation icon on the information carrier which, when this is read off by the user unit, is interpreted as a command to the user unit that it is to dispatch the message. Activation icons are described in greater detail in the above-mentioned WO 01/16691. Alternatively, the dispatch of the message can be controlled by pressing buttons on the user unit or by writing a special command or character with the user unit or in some other way that gives a signal to the user unit that the message has been recorded and can be dispatched.

The address server 7 responds by returning to the user unit computer network addresses corresponding to the coordinate area to which the coordinates belong. The user unit then sends coordinates corresponding to the products that the user wants to order to the network address, together with information that identifies the user 4.

The e-commerce site's 1 order-processing module 31 receives the coordinates from the user unit and converts these into an order in accordance with the second user's 4 specifications. In order to carry this out, the order-processing module utilizes stored information about which sub-coordinate areas correspond to which products, in a way corresponding to how the address server determined the network address. It can also utilize ICR software in order to interpret any information that the user may have written by freehand, for example order specifications. The order-processing module calculates an order amount as the sum of the prices of the products with the addition of any supplements such as carriage, postage or handling charges. The redemption module deducts the order amount from the credit amount 35. If the order amount exceeds the credit amount, the second user is asked whether he or she wants to pay the extra or to alter the content of the order.

### ALTERNATIVE EMBODIMENTS

A first embodiment has been described above, according to which the same unit or party administers the credit balance, provides products or services and administers orders for these products or services. In an alternative embodiment, a firs: party or unit can administer the credit balance and a second party or unit can provide products or services and administer orders for these products or services.

FIG. 11 shows in greater detail a first unit 1a that administers the credit balance, and a second unit 1b that provides products and administers orders for these products.

A first user 5 connects to the first unit 1a and orders a credit balance in a corresponding way to the way described above, The first unit la records the credit balance which a second user 4 is entitled to utilize. It can also inform the second user 4 that he is able to utilize a credit balance and/or inform the second unit 1b that there is a credit balance that can be utilized with the second unit 1b.

When the second user 4 wants to utilize his credit balance, he uses a user unit 3 and makes marks on an information carrier 2 which he can have obtained from the party that owns the unit 1a, from the party that owns the unit 1b or from elsewhere The coordinates that are recorded by means of the user unit 3 are sent to the unit 1b, optionally after the address of the unit 1b has been obtained from an address server (not shown in FIG. 11). The unit 1b determines to which coordinate area the coordinates obtained belong and thereby which product or service is ordered. The -unit 1b further determines, from the information received from the user unit 3, the identity of the second user.

Thereafter the unit 1b sends information to the unit la to the effect that the second user wants to buy goods to the value of a certain order amount. The first unit 1a checks whether there is any credit balance for the second user. If such is the case, the first unit 1a deducts the order amount from the credit balance and transfers the order amount to the second unit 1a.

As an alternative, the first unit 1a can transfer the whole credit balance to the second unit 1b as soon as the credit balance is recorded. The second unit can then check itself when an order is obtained whether there is any credit balance which the second user can utilize and if so deduct the order amount from this credit balance This alternative can be suitable when there is a single unit or party with which she credit balance can be utilized. If there are several units or parties with which the credit balance can be utilized, the former alternative can be more suitable.

As another alternative, the first unit 1a can transfer a predetermined credit balance per month as a standing instruction.

The present invention has now been described by means of two embodiments. These are just examples of how the invention can be realized. Many modifications can be made. Below follow examples of possible modifications.

As an alternative, the order form can be an information carrier which is provided with a position-coding pattern. The first user can thus enter a credit amount, identification information that identifies the second user and payment information via the form and a user unit of the type described above, after which the form is transmitted to the e-commerce site.

However, the order does not need to be made in electronic form. It can also be sent by mail or placed verbally by telephone or be a predetermined order, for example issued automatically monthly.

The identification information can also be a unique code that indicates the second user's 4 user unit 3, a customer number, a telephone number, a civic registration number, address information or some other type of information that is sufficient to identify the second user 4 unambiguously.

The payment information can be a credit card or debit card number, but also a bank account number, a customer or account number at the e-commerce site, a telephone number or some other information that makes it possible for the e-commerce site 1 to receive an amount corresponding to the credit amount 35 from the first user 5.

If the first user uses a user unit and a sheet of paper or the like which is provided with position-coding patterns to order the credit balance, the payment information can consist of the user unit's identity code, which can then be transmitted automatically to the e-commerce site with the order. The e-commerce site can then utilize, for example, an account associated with the identity code in order to obtain payment for the credit balance.

The electronic message that is sent to the second user to inform him or her that he or she has a credit balance to utilize, does not need to contain explicit information, but can also contain information about where information about the credit balance can be found, for example a link.

The payment from the first user's account-keeping institute 12 to the e-commerce site's account-keeping institute 11 can be carried out at the time when the first user orders the electronic gift certificate, that is the credit balance, but also at any other subsequent time, for example when the second user utilizes the amount by buying goods on the e-commerce site.

As an alternative, the information carrier can be a document that the second user prints out himself on a printer that provides a sufficiently high quality for the reproducing of the position-coding pattern. The information carrier can also be an information carrier which is provided prior to, or independently of, the first user entering the credit balance on the e-commerce site, such as an advertising brochure or a mail-order catalogue which is sent at regular intervals to a number of customers.

The information carrier can have one or more option boxes or fields that are provided with the position-coding pattern. It can, however, also be provided with position-coding patterns over all or large parts of its surface.

Optionally, one or more pares of the system in FIG. 1 can be combined into one unit. Examples of such combinations are the address server 7 and the payment server 10, which both or individually could be integrated into one unit with the e-commerce site 1. One or both of the account-controlling institutes 11, 12 can be integrated with the payment server 10. The payment server and both account-controlling institutes do not need to be incorporated in the system, The payment can be credited to the e-commerce site in some other way, for example by the person placing the order paying the credit balance against an invoice or by the e-commerce site keeping accounts itself into which persons placing orders can make payments for credit balances.

If the user unit contains information that makes it possible for the user unit itself to identify where the recorded coordinates are to be sent, then the address server is not needed at all.

It is also possible that the user unit 3 could be provided with such functionality that the terminal 8 could be integrated with the user unit 3.

It is not necessary for the user unit to convert the recorded position-coding pattern into coordinates itself. The user unit can instead transmit more or less processed versions of the sensor images to same external unit that converts the position-coding pattern into coordinates.

The first and second user may be the same person.

Finally, it should be stressed that a credit balance can be valid and can be utilized to buy one or more products from one or more companies.

The invention has been described above with reference to several embodiments and variants. However, the described embodiments are given only for explaining the invention, which is not limited to the embodiments described. Specifically, any combination of features from one embodiment to another is possible within the scope of the invention, The invention is only limited by the appended patent claims.

1. A method for issuing and redeeming gift certificates on an e-commerce site, comprising the steps of:
receiving an order for a gift certificate from a first user, which order comprises at least a credit amount and information for identifying a second user who is to be permitted to utilize the credit amount;
providing an information carrier to the second user, which information carrier is provided with a position-coding pattern which codes coordinates for a plurality of points on an imaginary surface, which points represent at least one product offered by the e-commerce site;
receiving coordinates for at least one point of said plurality of points and information that identifies the second user, from the second user, via a computer network;
identifying the credit amount that the second user is entitled to utilize, by means of the information that identifies the second user; and
deducting from the credit amount an amount corresponding to a price of the product corresponding to the received coordinates

2. A method according to claim 1, wherein the step of receiving coordinates comprises:
receiving coordinates for a series of points among said plurality of points; and
determining a specification of the product on the basis of a positional relationship between the points in the series.

3. A method according to claim 1 or 2, further comprising the step of:
receiving payment information from the first user, which payment information makes possible the utilization of an amount corresponding to the credit amount from a payment account associated with the first user.

4. A method according to claim 1, further comprising the stem of:
sending an electronic message to the second user comprising at least information about the credit amount.

5. A method according to claim 1, further comprising the step of:
receiving coordinates for at least two points of said plurality of points from the second user, via the computer network, which coordinates correspond to at least two products.

6. A method according to claim 1, wherein the information carrier (2) in a printed medium.

7. A method according to claim 1, wherein the information that identifies the second user is an identification code that defines a user unit which the second user used to record said coordinates.

8. A method for the utilization of a credit balance on an e-commerce site, which method comprises the steps of:
recording electronically coordinates for at least one point from an information carrier, which is provided with a position-coding pattern, which codes coordinates for a plurality of points on an imaginary surface, which points represent at least one product offered by the e-commerce site, by reading off the position-coding pattern by means of a user unit; and
sending to the e-commerce site, by means of the user unit via a computer network, said at least two coordinates and information that makes it possible to identity a credit balance that is to be used for paying for the product.

9. A method according to claim 8, further comprising the step of:
giving approval for the e-commerce site to deduct the payment for the product from the credit amount.

10. A method according to claim 8 or 9, further comprising the step of:
receiving from the e-commerce site an electronic message comprising at least the credit amount.

11. A method according to claim 8, further comprising the step of:
producing a specification of the product by writing the specification on the position-coding pattern using the user unit, so that the specification is recorded electronically in the form of a series of coordinates.

12. A method according to claim 8, wherein the information carrier is a printed medium.

13. A device for Providing and utilizing a credit balance on an e-commerce site, comprising:
an order-processing module, which is arranged to receive information From a second user which identifies the second user and coordinates for at least one point on an imaginary surface, which coordinates have been recorded by reading off a position-coding pattern on an information carrier by means of a user unit, which position-coding pattern codes coordinates for a plurality of points on the imaginary surface, which points represent at least one product offered by the e-commerce site; and
a redemption module, which is arranged to identify a credit amount that the second user is entitled to use by means of information that identifies the second user, and to deduct an amount corresponding to a price of the product from the credit amount.

14. A device according to claim 13, further comprising a message-generation module for generating a message to the second user, comprising at least the credit amount.

15. A device according to claim 13 or 14, which device is accessible via a standardized World Wide web protocol.

16. A device according to claim 13, further comprising an electronic order form for ordering the credit balance, which order form comprises space for specifying at least a credit amount and information for identifying the second user.

17. A computer program product comprising programs for issuing and redeeming gift certificates on an e-commerce site, which program when executed carries out the steps of:
receiving an order for a credit balance from a first user, which order comprises at least a credit amount and information for identifying a second user who is to be permitted to utilize the credit amount;
receiving from the second user, via a computer network, coordinates for at least one point on an information carrier which is provided with a position-coding pattern which codes coordinates for a plurality of points on an imaginary surface, which points represent at least one product offered by the e-commerce site, and information that identifies the second user;
identifying the credit amount that the second user is entitled to utilize, by means of the information that identifies the second user; and
deducting from the credit amount an amount corresponding to a price of the product corresponding to the received coordinates.

18. A computer program product according to claim 17, which program when executed carries out the further step of receiving coordinates for a series of points among said plurality of points, and further comprising the step of determining a specification of the product on the basis of a mutual relationship between the points in the series.

19. A computer program product according to claim 17 or 18, which program when executed carries out the further step of receiving payment information from the first user, which payment information makes it possible to obtain an amount corresponding to the credit amount from a payment account associated with the first user.

20. A computer program product according to claim 17, which program when executed carries out the further step of sending an electronic message to the second user comprising at least information about the credit amount.

21. A computer program product according to claim 17, which program when executed carries out the further step of receiving from the second user, via the computer network, coordinates for at least two points of said plurality of points, which coordinates correspond to at least two products.

22. A product package for providing and utilizing a credit balance on an e-commerce site, comprising:
at least one information carrier which is provided with a position-coding pattern which codes coordinates for a plurality of points on an imaginary surface, which points represent at least one product offered by the e-commerce site;
at least one user unit, for recording electronically said position-coding pattern; and
at least one credit balance on the e-commerce site.
